(19) United States
(12) Patent Application Publication
(10) Pub. No.: US 2008/0231032 A1
(43) Pub. Date: Sep. 25, 2008

(54) Telescopic device having protruding distance member

(75) Inventor: Jae Moon Oh, Chungcheongnam-do (KR)

Correspondence Address: HARNESS, DICKEY & PIERCE, P.L.C., P.O. BOX 828, BLOOMFIELD HILLS, MI, 48303, US

(73) Assignee: Mando Corporation

(21) Appl. No.: 12/075,427

(22) Filed: Mar. 11, 2008

(30) Foreign Application Priority Data
Mar. 19, 2007 (KR) 10-2007-0026788

(51) Int. Cl. B62D 1/185

(52) U.S. Cl. 280/775

(57) ABSTRACT

A telescopic device includes an inner tube; an outer tube having an opening formed on an end so that the opening partially extends in a longitudinal direction; upper mounting brackets; a lever; and a protruding distance member fixed to an outer peripheral surface of the outer tube and provided with a protrusion inserted into the opening and fasteners to be mounted on the upper mounting brackets. The protrusion is adapted to compress the inner tube when the lever is fastened so that the inner and outer tubes are fixed to each other. By replacing the conventional telescopic bush with the distance member, the telescopic force is reduced when the lever is unfastened. In addition, when the lever is fastened, the inner peripheral surface and the protruding surface of the distance member strongly compress both the outer and inner tubes. This increases the rigidity of the steering device during driving.

### CROSS-REFERENCE TO RELATED APPLICATION

This non-provisional application claims priority under 35 U.S.C §119(a) on Patent Application No. 10-2007-0026788 filed in Korea on Mar. 19, 2007, the entire contents of which are hereby incorporated by reference.

### BACKGROUND OF THE INVENTION

1. Field of the Invention

The present invention relates to a telescopic device having a protruding distance member. More particularly, the present invention relates to a telescopic device having a protruding distance member which replaces the conventional telescopic bush made of injection-molded plastic, and which has a protrusion of a predetermined area formed on a part of its inner peripheral surface so that, after the lever is fastened, the protrusion extends through the outer tube and compresses the inner tube, thereby increasing the combined rigidity of the outer and inner tubes.

2. Description of the Prior Art

As generally known in the art, automobiles have a steering column installed in front of the driver's seat to transmit rotational force from the steering wheel to the wheels via the gearbox, as well as a tilt and telescopic device for adjusting the position of the steering wheel according to the driver's physical condition.

The tilt function is used to adjust the angle at which the steering wheel is fixed, and the telescopic device has two hollow tubes inserted therein so that it can extend and contract in the axial direction.

FIG. 1 is a lateral view of a conventional steering column 100, which includes a distance bracket 120, an outer tube 130, an inner tube 140, a telescopic bush 150, an upper mounting bracket 160, and a lower mounting bracket 170.

The tilt and telescopic device 190 is based on a mechanism for modifying the position of the steering wheel (not shown) by operating the lever 180. The tilt operation is conducted by unfastening the lever 180, modifying the position of the fixing bolt 125 along the guideline 135, and fastening the lever 180 again. The tilt spring 110 is adapted to prevent the gravity from abruptly pulling down the steering wheel. The tilt spring 110 also lessens the amount of force needed by the driver to lift the steering wheel.

The telescopic operation is based on a mechanism for extending and contracting the steering column 100. More particularly, the telescopic operation is conducted by unfastening the lever, modifying the position of the fixing bolt 125 along the fastening hole 145 formed on the distance bracket 120, and fastening the lever 180 again.

The telescopic bush 150 is inserted between the outer peripheral surface of the inner tube 140 and the inner peripheral surface of the outer tube 130 so that, when the inner tube 140 is slid in the axial direction to adjust the displacement of the steering column, smooth sliding can occur.

Meanwhile, it has recently been a trend to lower the idle RPM of automobile engines for better fuel economy. The engine vibration becomes worse at lower RPMs, but this problem is substantially alleviated by a rubber engine mount, which fixes the engine to the chassis, and which absorbs the vibration to certain extent. However, from the point of view of the steering device, the telescopic bush 150 needs to have increased rigidity to prevent the steering device from resonating when the idle RPM is low. In addition, the telescopic force must be kept low so that, when the lever 180 has been unfastened, a smooth telescopic operation is guaranteed.

However, the telescopic force is proportional to the rigidity of the telescopic bush 150, which is inserted between the outer and inner tubes 130 and 140. In other words, it is impossible to both increase the rigidity of the bush 150 and decrease the telescopic force.

### SUMMARY OF THE INVENTION

Accordingly, the present invention has been made to solve the above-mentioned problems occurring in the prior art, and the present invention provides a telescopic device having a protruding distance member which replaces the conventional telescopic bush made of injection-molded plastic, and which has a protrusion of a predetermined area formed on a part of its inner peripheral surface so that, after the lever is fastened, the protrusion extends through the outer tube and compresses the inner tube, thereby increasing the combined rigidity of the outer and inner tubes.

In accordance with an aspect of the present invention, there is provided a telescopic device for an automobile steering apparatus, the telescopic device including an inner tube; an outer tube having an opening formed on an end so that the opening partially extends in a longitudinal direction; upper mounting brackets; a lever; and a protruding distance member fixed to an outer peripheral surface of the outer tube and provided with a protrusion inserted into the opening and fasteners to be mounted on the upper mounting brackets, wherein the protrusion is adapted to compress the inner tube when the lever is fastened so that the inner and outer tubes are fixed to each other.

### BRIEF DESCRIPTION OF THE DRAWINGS

The above and other objects, features, and advantages of the present invention will be more apparent from the following detailed description taken in conjunction with the accompanying drawings, in which:

FIG. 1 is a lateral view of a conventional steering column;

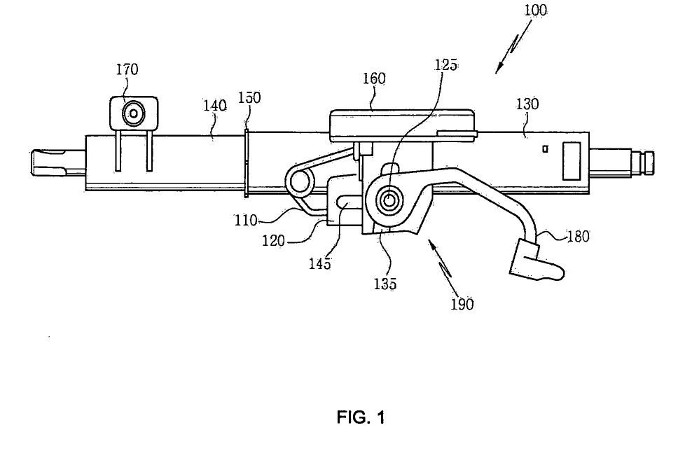

FIG. 2 is a perspective view of a telescopic device according to an exemplary embodiment of the present invention; and

FIG. 3 is a front view of a protruding distance member according to an exemplary embodiment of the present invention.

### DETAILED DESCRIPTION OF THE EXEMPLARY EMBODIMENTS

Hereinafter, an exemplary embodiment of the present invention will be described with reference to the accompanying drawings. In the following description and drawings, the same reference numerals are used to designate the same or similar components, and so repetition of the description on the same or similar components will be omitted. Furthermore, a detailed description of known functions and configurations incorporated herein is omitted to avoid making the subject matter of the present invention unclear.

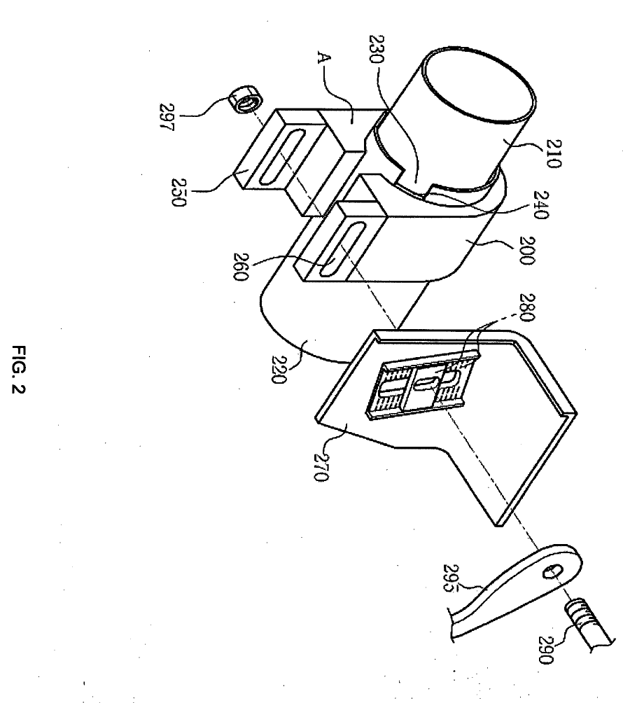

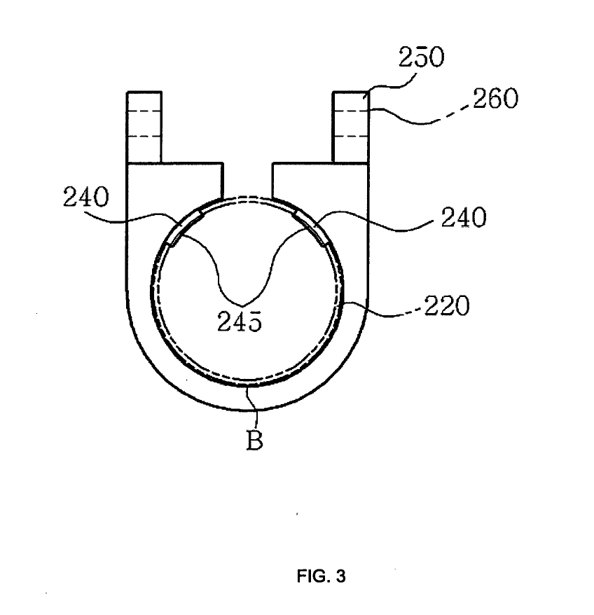

FIG. 2 is a perspective view of a telescopic device according to an exemplary embodiment of the present invention, and FIG. 3 is a front view of a protruding distance member according to an exemplary embodiment of the present invention. The telescopic device according to the present invention includes an inner tube 210, an outer tube 220, and a protruding distance member 200.

The inner and outer tubes 210 and 220 have the shape of pipes, and a portion of the inner tube 210 is inserted into the outer tube 220. The outer tube 220 has an opening 230 of a predetermined width formed on its outer peripheral surface in the longitudinal direction.

The opening 230 extends throughout the outer tube 220. For convenience of assembly, the opening 230 is preferably open to an end of the outer tube 220 as shown in the drawing.

The protruding distance member 200 has an approximately U-shaped section, and is mounted to surround the portion of the outer peripheral surface of the outer tube 220 on which the opening 230 is formed. The protruding distance member 200 has a protrusion 240 formed on its inner peripheral surface to be inserted into the opening 230.

It will be assumed that the longitudinal size of the outer tube 220 is its length, and the circumferential size thereof is its width. Then, the opening 230 preferably has a length equal to or larger than that of the protrusion 240 so that, when the protrusion 240 is inserted into the opening 230, an end A of the protruding distance member coincides with an end of the outer tube 220, or the end of the outer tube 220 protrudes from the end A of the protruding distance member 200 by inserting the protruding distance member 200 a little further.

The protrusion 240 has a square shape so that, when the lever 295 is fastened to increase the fastening force, the protrusion 240 extends throughout the opening 230 and abuts the inner tube 210. The leading surface of the protrusion 240, which abuts the inner tube 210, is preferably rounded to have the same radius of curvature as that of the outer peripheral surface of the inner tube 210. The protrusion 240 has a width similar to that of the opening 230 formed on the outer tube 220 so that the protrusion 240 is inserted into the opening. The protrusion 240 may span the entire length of the protruding distance member 200, or only a part of it. Those skilled in the art can easily understand that the entire length of the protruding distance member 200 or the length of the protrusion 240 relative to the same can be adjusted to control the load according to the load design of the steering device, which is specific to each vehicle type.

In addition, an elastic body 245 may be placed on the leading surface, which abuts the inner tube 210, to increase the frictional force when the lever 295 is fastened. The elastic body 245 is preferably made of rubber, and acts as a type of a friction pad.

The U-shaped protruding distance member 200 has fasteners 250 formed on both upper portions, respectively, so that, when the lever 295 rotates, the created fastening force is transmitted to it.

After being mounted on the outer tube 220, the protruding distance member 200 needs to be fixed to prevent it from escaping from the outer tube 220. Preferably, only the lower portion B of the U-shaped protruding distance member 200 is fixed by spot welding, for example, to such an extent that it does not escape from the outer tube 220.

By fixing the protruding distance member 200 in this manner, it comes to easily undergo elastic deformation when the lever 295 is rotated to compress the fasteners 250 from both sides. As a result, the protrusion 240 fixes the inner tube 210 more easily.

Each fastener 250 has a fastening hole 260 extending in the longitudinal direction. The protruding distance member 200 has upper mounting brackets 270 positioned on both sides, respectively. A fixing bolt 290 is inserted to extend through the upper mounting brackets 270, the fastening holes 260, and a gear mechanism 280. The lever 295 is fixed to one side of the fixing bolt 290, and a fixing nut 297 is placed on the other side.

The fastening holes 260 limit the range of telescopic movement of the steering wheel (not shown) when the lever 295 is unfastened. Therefore, the length of the fastening holes 260 can be varied depending on the vehicle type. In addition, the axial length and the radial width of the opening 230 and the protrusion 240 can be varied according to the load characteristics of the steering column, which are specific to each vehicle type.

If the lever 295 is rotated for fastening, the fixing bolt 290 rotates and undergoes a relative movement with regard to the fixing nut 297. Then, pressure is applied to the fasteners 250 of the protruding distance member 200, and reduces the distance between them. Finally, the protrusion 240 compresses the inner tube 210, which is then fixed to the outer tube 220.

If the lever 295 is unfastened, the elastic force from the protruding distance member 200 returns the protrusion 240, which has been compressing the inner tube 210, to its original position, and the gear mechanism is unfastened. Then, the protrusion 240 is separated from the inner tube 210 and allows tilt and telescopic operations. More particularly, the protrusion 240 is completely separated from the inner tube 210 so that the outer tube 220 can be freely adjusted without any operational resistance.

As mentioned above, the telescopic device having a protruding distance member according to the present invention is advantageous in that, by replacing the conventional telescopic bush with the distance member, the telescopic force is reduced when the lever is unfastened. In addition, when the lever is fastened, the inner peripheral surface and the protruding surface of the distance member strongly compress both the outer and inner tubes. This increases the rigidity of the steering device during driving.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A telescopic device for an automobile steering apparatus, the telescopic device comprising:
an inner tube;
an outer tube having an opening formed on an end so that the opening partially extends in a longitudinal direction;
upper mounting brackets;
a lever; and
a protruding distance member fixed to an outer peripheral surface of the outer tube and provided with a protrusion inserted into the opening and fasteners to be mounted on the upper mounting brackets, wherein
the protrusion is adapted to compress the inner tube when the lever is fastened so that the inner and outer tubes are fixed to each other.

2. The telescopic device as claimed in claim 1, wherein the opening is open to the end of the outer tube.

3. The telescopic device as claimed in claim 1, wherein the protrusion has a leading surface abutting the inner tube, the leading surface being rounded to have an identical radius of curvature as the outer peripheral surface of the inner tube.

4. The telescopic device as claimed in claim 1, wherein the fasteners have fastening holes extending in a longitudinal direction of the protruding distance member to be fastened to the upper mounting brackets, respectively.

5. The telescopic device as claimed in claim 3, further comprising an elastic body on the leading surface to increase frictional force with regard to the inner tube when the lever is fastened.
